(19) United States
(12) Patent Application Publication
(10) Pub. No.: US 2022/0309537 A1
(43) Pub. Date: Sep. 29, 2022

(54) Portable Real Estate Reservation

(71) Applicant: Productive Application Solutions, Inc., Sheridan, WY (US)

(72) Inventors: Peter Ta, Tucson, AZ (US); Gerald Maliszewski, San Diego, CA (US)

(21) Appl. No.: 17/830,783

(22) Filed: Jun. 2, 2022

Related U.S. Application Data
(63) Continuation-in-part of application No. 17/830,412, filed on Jun. 2, 2022.
Application No. 17/830,412 is a continuation-in-part of application No. 17/230,008, filed on Apr. 14, 2021, now Pat. No. 11,270,349.
Application No. 17/230,008 is a continuation-in-part of application No. 17/201,419, filed on Mar. 15, 2021.
Application No. 17/201,419 is a continuation-in-part of application No. 17/179,574, filed on Feb. 19, 2021, now Pat. No. 11,257,120.
Application No. 17/179,574 is a continuation-in-part of application No. 17/168,313, filed on Feb. 5, 2021.
Application No. 17/168,313 is a continuation-in-part of application No. 17/133,722, filed on Dec. 24, 2020, now Pat. No. 11,055,743.
Application No. 17/133,722 is a continuation-in-part of application No. 17/097,256, filed on Nov. 13, 2020.
Application No. 17/097,256 is a continuation-in-part of application No. 17/071,043, filed on Oct. 15, 2020, now Pat. No. 11,037,199.
Application No. 17/071,043 is a continuation-in-part of application No. 17/023,546, filed on Sep. 17, 2020, now Pat. No. 10,991,007.
Application No. 17/023,546 is a continuation of application No. 17/007,575, filed on Aug. 31, 2020.
Application No. 17/007,575 is a continuation of application No. 16/869,696, filed on May 8, 2020, now Pat. No. 10,803,488.
Application No. 16/869,696 is a continuation of application No. 16/601,362, filed on Oct. 14, 2019, now Pat. No. 10,796,340.
(60) Provisional application No. 63/310,857, filed on Feb. 16, 2022.
(60) Provisional application No. 62/779,972, filed on Dec. 14, 2018.

(51) Int. Cl. G06Q 30/02; G06F 16/487; G05D 1/00

(52) U.S. Cl. CPC G06Q 30/0266; G06Q 30/0252; G06Q 30/0267; G06Q 30/0244; G06F 16/487; G05D 1/0022; G05D 1/0094

(57) ABSTRACT

A system and method are disclosed permitting the reservation of a publically accessible stationary location, such as a parking spot along a public highway, a parking lot, or a parking ramp. In some aspects, selection of mobile unit types, media messages to be presented, and/or the times that the stationary location is to be occupied by a reserving mobile unit is permitted. The system may also determine a value assigned to the locations or other of the above-mentioned characteristics. The mobile unit makes a determination of its geographic location and transmits the geographic location, and also sends an acknowledgement that the mobile unit occupies the selected location. The mobile unit may be a self-powered vehicle, towable vehicle, portable station, ground vehicle, nautical vehicle, and airborne vehicle.

### RELATED APPLICATIONS

Any and all applications, if any, for which a foreign or domestic priority claim is identified in the Application Data Sheet of the present application are hereby incorporated by reference under 37 CFR 1.57.

### BACKGROUND OF THE INVENTION

### 1. Field of the Invention

This invention generally relates to the reservation of public access locations and, more particularly, to a system and method for using mobile platforms to reserve and occupy publically accessible stationary locations.

### 2. Description of the Related Art

Market research shows that outdoor billboard marketing space has increasingly become harder to find and, hence, more valuable. At the same time, automotive vehicles are one of the most costly expenses incurred by the average consumer. Ironically, most automobiles sit idle for a large portion of the day. U.S. Pat. No. 10,796,340, entitled SYSTEM AND METHOD FOR TARGETING THE DISTRIBUTION OF MEDIA FROM A MOBILE PLATFORM, invented by Peter Ta et al., and filed on Oct. 14, 2019, addresses to problem of finding more outdoor advertising space by providing an automotive targeted parking system that adds to an automobile the additional feature of a media display subsystem, and which may also include a Wireless Local Area Network (WLAN) IEEE 802.11 (WiFi) access point (hotspot).

While the above-described system addresses the provision of additional outdoor advertising through the “gig economy” use of automobiles, the act of parking remains a potential issue. Parking in many desirable advertising locations in metropolitan areas is often limited to one or two hours only. Further, the necessity of frequently changing parking spots can become a burden and may make the use of their automobile as a mobile media center impractical for some owners.

Parent U.S. Pat. No. 10,991,007, entitled AERIAL BILLBOARD, invented by Peter Ta et al., and filed on Sep. 17, 2020, provides for the use of aircraft, such as unmanned aerial vehicles (UAVs), as another type of media platform.

Parent U.S. Pat. No. 11,037,199, entitled SYSTEM AND METHOD FOR GIG VEHICLE PARKING, invented by Peter Ta et al., and filed on Oct. 15, 2020, describes a publically accessible access point that reports its enablement and position at a targeted parking position.

Parent U.S. Pat. No. 11,138,634, entitled GIG VEHICLE PARKING, invented by Peter Ta et al., with a filing date of May 6, 2021, describes a system that permits agents to deliver selected mobile platforms to corresponding locations.

Parent U.S. Pat. No. 11,138,635, entitled MOBILE MEDIA TOPPER, invented by Peter Ta et al., with a filing date of May 10, 2021, describes a media projection topper that receives a reward in response to reporting the durations of time that a media-presenting vehicle is stationary.

Parent U.S. Pat. No. 11,138,635, entitled SYSTEM AND METHOD FOR COORDINATED MOBILE MEDIA PROJECTION, with a filing date of Feb. 19, 2021, describes a system for coordinated multiple media projection system to present an integrated display from selected parking locations.

Parent U.S. Pat. No. 11,270,349, entitled PORTABLE BILLBOARD, filed on Apr. 14, 2021, provides a portable media projection subsystem that reports its enablement and stationary location at a selected weighted value target location.

It would be advantageous if desirable publically accessible locations and parking spots could be efficiently reserved. It would be advantageous if mobile units parked in reserved locations could be used to present media messages, provide public services, such as temporary lockers, or be taken possession of by clients.

### SUMMARY OF THE INVENTION

A system and method are disclosed herein for an online dashboard that permits the reservation of a publically accessible stationary location, such as a parking spot along a public highway, a parking lot, or a parking ramp. In some aspects, the dashboard also permits the selection of mobile unit types, media messages to be presented, and/or the times that the stationary location is to be occupied by a reserving mobile unit. The system may also determine a value assigned to the locations or other of the above-mentioned characteristics.

If the reserved mobile units are used to present media, their media projection subsystems can be distinguished from conventional signage in their ability the measure the efficacy of the projected media, and/or access point (AP) communications, and/or cellular boosted communications. One measurement is location, as some locations attract more attention than others. Another measurement is actual enablement, meaning the times and duration that the media is actually seen by the public. To encourage efficient deployment, the entities contracting for or managing the media projection subsystems are rewarded based upon these efficacy measurements. Being portable, the media projection subsystems may act as an advertising platform that seeks to expand and capture market share within the outdoor advertising market segment by directing the selective deployment of media to preferred target locations. The system may transmit the following information: (i) a unique identifier for the device in use (for example, radio-frequency identification), (ii) the time, date, duration, and location (using global positioning satellite (GPS) or cellular triangulation systems), (iii) an indication that the media unit is occupying the assigned location, and (iv) an indication that the media projection subsystem, WLAN/WPAN access point, cellular booster, or Internet booster is in use. Graphic information system (GIS) mapping technology may be used to compensate a person or business entity associated with the system for operating in specified locations.

Accordingly, a method is provided for reserving publically accessible real estate locations. The method uses a site table to list a plurality of publically accessible stationary locations. In one aspect, the site table cross-references stationary locations to weighted values. The site table accepts stationary location requests and then supplies location reservation directions to a mobile unit, for a selected location. A mobile unit accepts reservation directions and occupies the selected location. The mobile unit makes a determination of its geographic location and transmits the geographic location, and also sends an acknowledgement that the mobile unit occupies the selected location. The mobile unit may be a self-powered vehicle, towable vehicle, portable station, ground vehicle, nautical vehicle, and airborne vehicle. The site table may optionally cross-reference publically accessible stationary locations to types of mobile units.

In one aspect, the site table sends occupation instructions for a first mobile unit receiving direction instructions so that possession of the first mobile unit occurs as a result of the occupation instructions. For example, the mobile unit may be a recreational vehicle that a client wishes to take possession of at a particular location. The mobile unit may transmit an acknowledgement that possession has occurred. In another aspect, subsequent to possession of the first mobile unit, the client is permitted to drive and/or move the mobile unit to a new location.

In one variation the site table assigns stationary locations to mobile units, prior to their potential selection. Subsequent to a mobile unit moving to an assigned stationary location, it transmits an acknowledgement to the site table and the site table is updated to list the first mobile unit as being positioned at the assigned location. Alternatively, mobile units are assigned to locations, after the locations have been selected by a client.

The reserving mobile unit may also be used to transceive publically accessible communications using a device such as a cellular telephone local booster, Internet booster, an IEEE 802.11 Wireless Local Area Network (WLAN) and/or IEEE 802.15 Wireless Personal Area Network (WPAN) access point (AP). The mobile units may also be used to project media messages using a media projection subsystem.

In another aspect, the site table receives messages from mobile units indicating the occupation, or the intended occupation, of an independently selected stationary location. That is, the stationary location is selected by the mobile unit, as opposed to being selected by the site table. The site table then updates listings to include the addition of the independently selected stationary locations. In another variation, the site table accepts requests for adding of a suggested stationary location to the site table, a suggested mobile unit to the site table, or a suggested stationary location cross-referencing a suggested mobile unit to the site table. The site table updates the listing in response to the requests, if they are accepted. A scouting subsystem, including a roving car, drone, or parking meter monitoring service, may determine the occupation status of stationary locations and report the occupation status to the site table. The site table then updates its listings to note the occupation status of the stationary locations.

In one aspect, the mobile units may transmit local environmental data such as photo/video images, sounds, weather, odors, photodetection, chemical analysis, wireless spectrum analysis, wireless service traffic analysis, radioactivity analysis, and combinations thereof. The site table may then update the weighted values of locations in response to the local environmental data.

Additional details of the above-described method and a system for reserving publically accessible real estate locations are provided below.

### BRIEF DESCRIPTION OF THE DRAWINGS

FIG. 1 is a schematic block diagram depicting a system for reserving publically accessible real estate locations.

FIGS. 2A through 2C are diagrams depicting exemplary site table cross-referencing.

FIGS. 3A through 3F depict some exemplary ground-based mobile unit types.

FIG. 4 is a diagram depicting a scouting subsystem.

FIG. 5 is a schematic block diagram depicting an exemplary mobile unit.

FIG. 6 is a plan view of geographic regions cross-referenced to the weighted value of various positions.

FIG. 7 is a flowchart illustrating a method for reserving publically accessible real estate locations.

### DETAILED DESCRIPTION

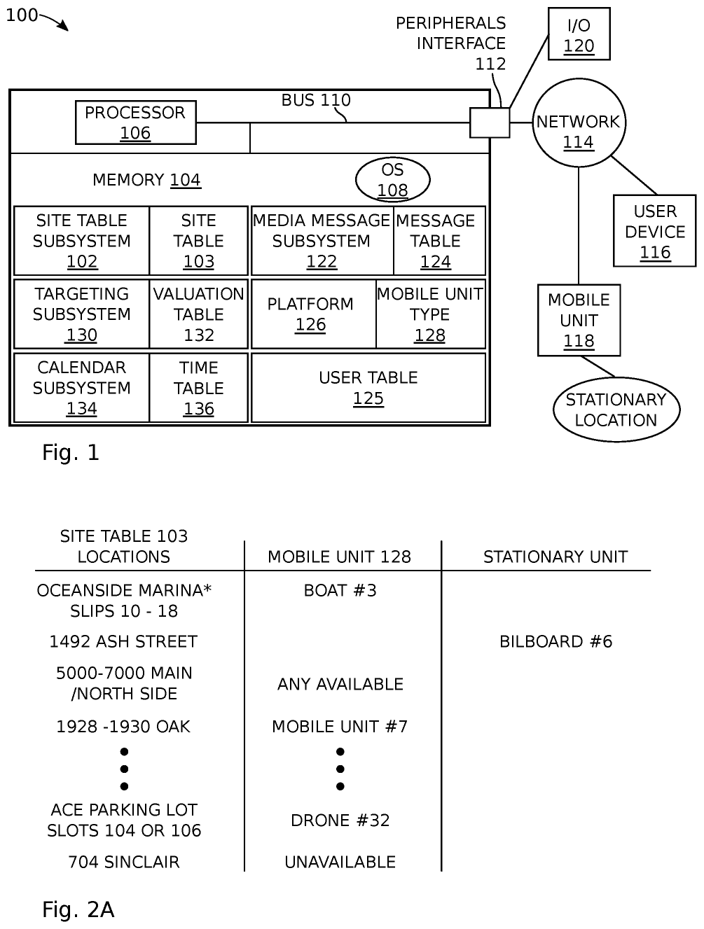

FIG. 1 is a schematic block diagram depicting a system for reserving publically accessible real estate locations. The system 100 comprises a site table subsystem 102 listing a plurality of publically accessible stationary locations. From the perspective of a user, the site table subsystem 102 may take the form of a graphical user interface (GUI). The site table subsystem 102 is typically the construct of a software application, as discussed in greater detail below. A site table subsystem interface accepts stationary location requests and supplying location reservation directions to a selected location.

As shown, the system 100 and site table subsystem 102 are enabled as a sequence of processor executable instructions stored in non-transitory memory 104. The site table subsystem 102 is associated with a database that includes site table 103. As is the case with the other types of tables presented below, the tables can alternatively be enabled with combinational hardware logic, or even be enabled as physical elements (e.g., paper or blackboards) managed by human operators. However, software enablement is likely to be the most efficient means of management. Thus, the overall system includes a processor 106 and an operating system (OS) 108 stored in memory 104. The site table subsystem interface is enabled through a system bus 110, connected to the memory 104, the processor 106, a peripherals interface 112, and a network 114. The network 114 may consist of hardwired (e.g., Ethernet), as well as wireless links (e.g., cellular, WiFi, and Bluetooth). The network 114 may be connected to a user device 116 (e.g., a smartphone or desktop computer), which may be the source of the location selections. In some cases the location selections may be sourced by the mobile unit 118, or by a locally connected peripheral input/output (I/O) subsystem 120 (e.g., a display, mouse, and keyboard).

The non-transitory memories described herein may be any type or form of non-volatile storage device or medium capable of storing data and/or other computer-readable instructions. Examples of memories include, without limitation, Read Only Memory (ROM), flash memory, or any other suitable memory device. Although not required, in certain embodiments, the system described herein may include both a volatile memory unit and a non-volatile storage device. The memory may be implemented as shared memory and/or distributed memory in a network device.

As is common in many computer systems or servers, processor 106 is connected to the bus line 110 to pull operating instructions from operating system 108 and software applications in memory 104, and manage communications between the various components of computer. For ease of understanding, the above-described functions have been described as individual components. However, it should be understood that in practice, multiple functions may be performed by a single device, subsystem, or software application. It should be understood that computer systems are well understood by persons with ordinary skill in the art, and in the interest of brevity, details of their operation have been omitted.

For convenience, all the above-mentioned components are shown embedded as a single schematic block, but it should be understood that these components are not necessarily embedded in a single hardware unit or server, or in communication with each other. Alternatively, the software applications may be cooperating components of an overall software system. The server may also represent a network of servers in communication with each other.

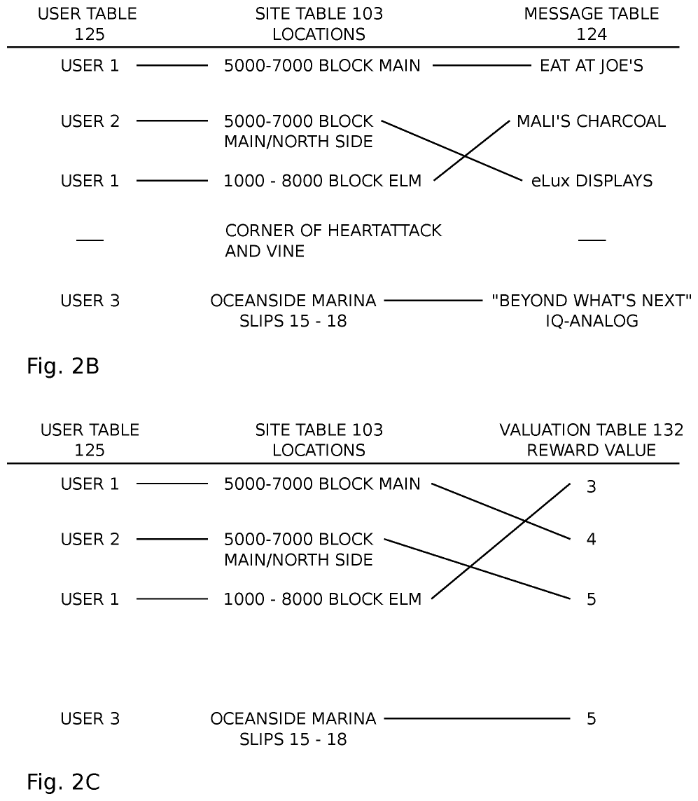

FIGS. 2A through 2C are diagrams depicting exemplary site table cross-referencing. As shown, the various users (clients) or media units (driver or media unit owner) have selected locations, and have cross-referenced them to selected media units. The site table 103 may list fixed stationary locations or putative stationary location (marked with an asterisk). For example, the “Oceanside Marina” location may be considered a putative location based upon tides, local boat traffic, and the boat captain's judgement. The selection of a putative stationary location may entail the acquiescing to one of several possible nearby locations, a best effort to find an available location near a desired location, or a best effort to find an available location guaranteed to be within a predetermined radius of a desired location. Billboard #6 is a fixed stationary location at 1492 Ash Street. The location 5000-7000 Main/north side is assigned to any mobile unit in that range of addresses. The Ace parking lot location is assigned to drone #32. 704 Sinclair, which may be a highly desirable location is unavailable, most likely because it is occupied by a vehicle that is not part of the system. Another optional feature is that the site table subsystem 102 accepts stationary location suggestions from a user (e.g., user device 116 or media unit 118) permitting the user to add a stationary location to the site table 103.

Returning to FIG. 1, a mobile unit 118 has an interface on network 114 to accept reservation directions and has the capacity to temporarily occupy selected locations. The mobile unit 118 may, for example, be a self-powered vehicle, towable vehicle, portable station, ground vehicle, nautical vehicle, or airborne vehicles. The mobile unit 118 typically comprises a location device, described below, to determine a geographic location of the mobile unit. A communication subsystem, described below, accepts the reservation directions, and supplies the geographic location and an acknowledgement that the mobile unit occupies the selected location.

In some aspects, the mobile unit 118 is already occupying the stationary location before receiving the reservation directions. A “stationary location” may be a parking location. “Parking” is typically understood to be location where a vehicle is temporarily left with its engine off, or if not self-powered, left without means of movement. Mobile units may be “parked” along city streets or in publicly accessible areas, such as parking lots. Mobile units are typically “parked” for limited durations of time, typically a matter of hours, but the durations can be as small as minutes or larger than even weeks. However, a location can also be stationary, such as might occur when a mobile unit is stopped at a traffic sign or when legally double-parked. “Temporary” is understood to be typically to be a duration of several minutes to several hours, although it may also be a matter of days or even weeks. “Occupation” is understood to mean filling a space or location so completely that another vehicle or entity is unable to fill that space. In the case of drone aircraft or boats, these vehicles may need to be powered with engines running to maintain a stationary location. In other aspects, the site table 103 has an interface for assigning locations to a mobile unit, prior to its selection, and the site table 103 is updated to list mobile units after being positioned at their assigned locations. Otherwise, the mobile unit 118 may be directed to a stationary location after the location is selected by a user.

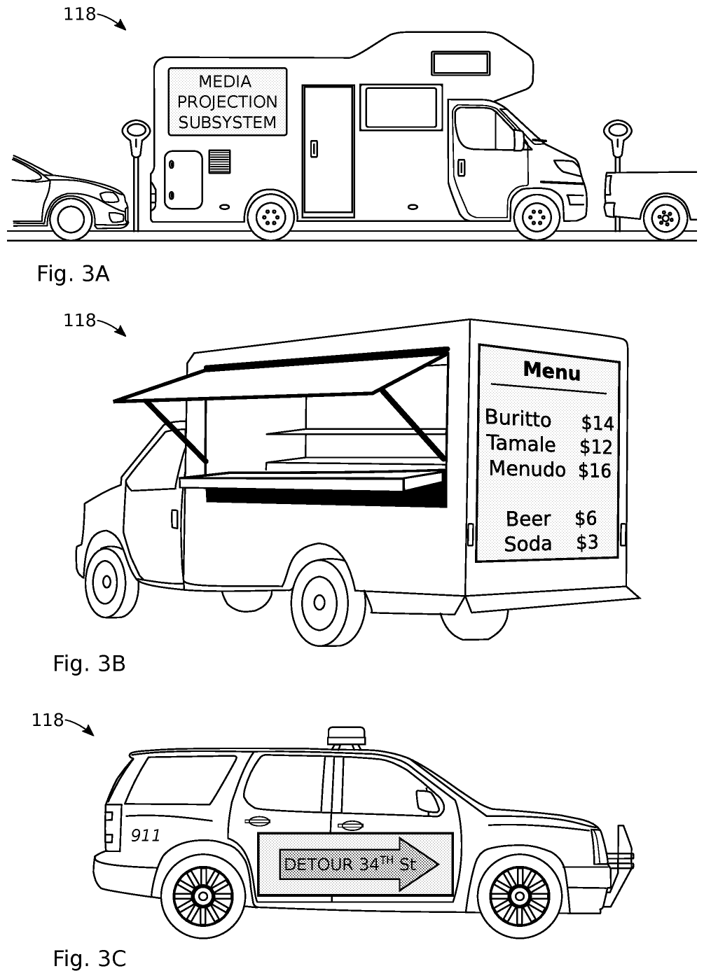

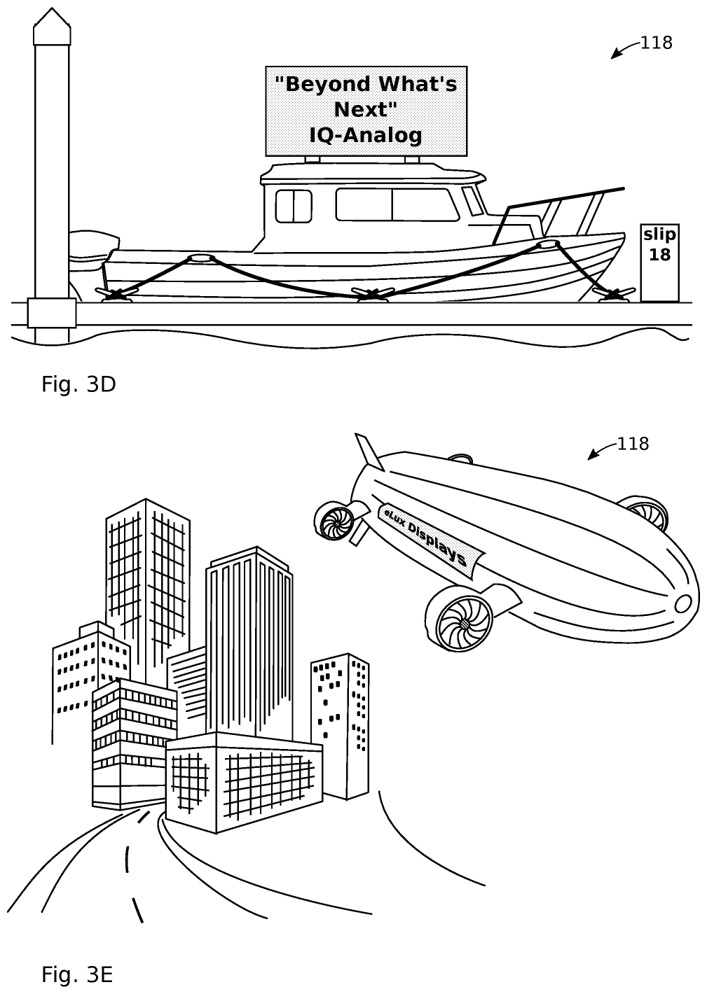

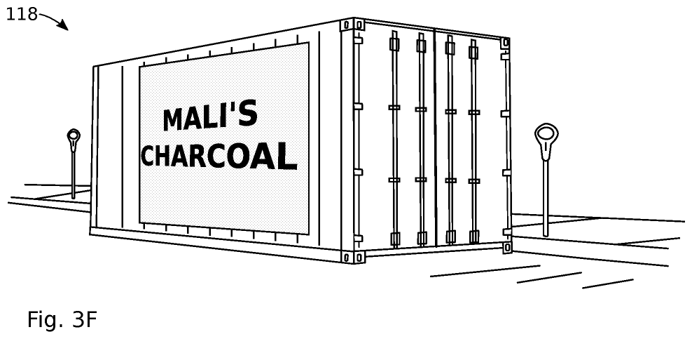

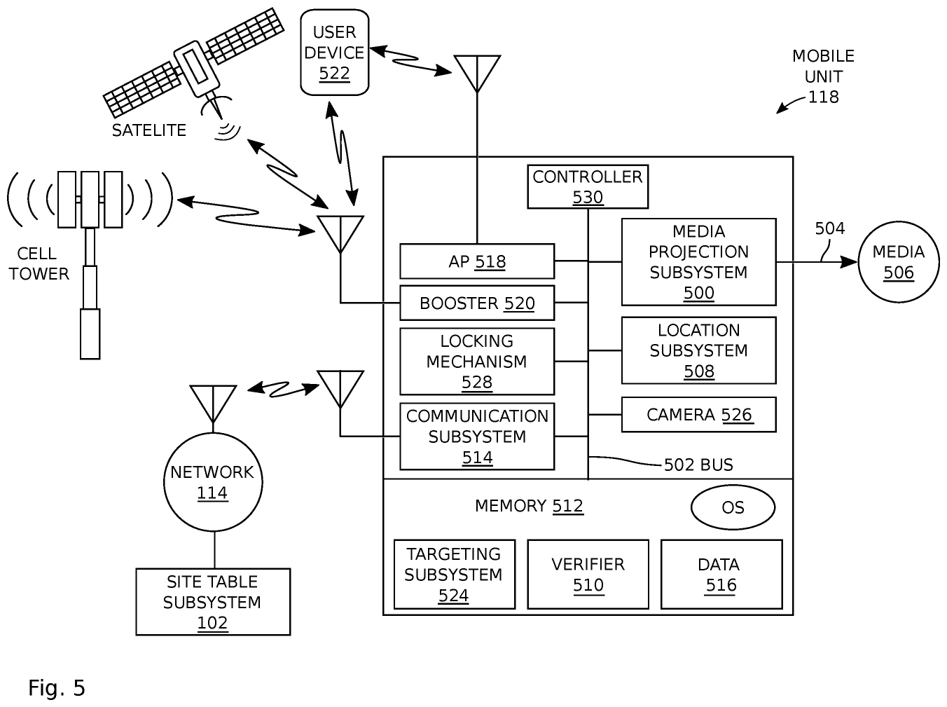

FIGS. 3A through 3F depict some exemplary ground-based mobile unit types. If the mobile units 118 are already occupying the selected stationary location, prior to their selection, then the direction instruction would be for the mobile unit to remain in place. In one aspect, the mobile unit 118 is capable of being possessed (controlled by a user). For example, a recreation vehicle (RV) may be possessed by a user or driver, see FIG. 3A. In that case, the site table interface sends occupation instructions to the RV mobile unit receiving direction instructions, so that possession of the mobile unit occurs in response to the occupation instructions. For example, the mobile unit 118 may be equipped with a digital or physical lock (see FIG. 5), and the user may be provided with a digital key (e.g., code) or physical key able to open the lock. The mobile unit 118 may be equipped with sensors (e.g., a digital lock) able to determine possession, and the mobile unit transmits an acknowledgement that possession has occurred. The mobile unit 118 may also include other sensors able to determine if mobile unit amenities (e.g., a snack bar) are being used.

In one aspect, the mobile unit 118 includes a control subsystem (see FIG. 5) that permits movement of the mobile unit subsequent to possession. For example, the mobile unit user may be provided with a digital code that permits users to engage the mobile unit ignition. The mobile units may also comprise a media projection subsystem, as explained in more detail below. In one aspect, the mobile unit may act as a placeholder and is moved upon the arrival of the user making the reservation, permitting the mobile unit to be replaced with a different mobile unit.

Other exemplary ground-based mobile unit types include conventional cars, trucks, and portable signs, as explained above. Some explicit examples include a mobile kitchen or food truck (FIG. 3B), police car (FIG. 3C), boat (FIG. 3D), air yacht (FIG. 3E), or pod (FIG. 3F) for storage, kitchen, street services, or motel. In the case of air or nautical vehicles, the launching site, landing site, or midair position may be the location that is reserved.

Returning to FIG. 1, the system 100 may further comprise a media message subsystem 122. The media message subsystem 122 may accept media message selections from message table 124 and supply media message enablement signals, for a selected media message, to the media unit 118. In one aspect, the media message subsystem transmits a selected media message to the media unit.

FIG. 2B is a diagram of a site table cross-referenced to an exemplary media message table 124 and user table 125.

Returning to FIG. 1, in one aspect, the mobile unit 118 is able to send a message to the site table 103 indicating the occupation of an independently selected stationary location. The site table 103 is then updated to list the addition of the independently selected stationary location. “Independently selected” refers to the ability of the mobile unit 104 or mobile unit operator to pick their own preferred stationary locations, such as might support the use of mobile units as a “gig” economy entity, similar to an Uber vehicle.

In some aspects the site table 103 cross-references publically accessible stationary locations to types of mobile units 118 using a platform subsystem 126 and mobile unit type table 128. Mobile unit types may be differentiated based upon whether they are capable of movement on the ground, air, or water. Within these categories the units may be graded on size or prestige value. In the ground category for example, users may be permitted to select between cars, luxury cars, and trucks. Or, within the air category, users may be permitted to select between small drones, large drones, fixed wing aircraft, or air yacht. Likewise, different types of boats may be available.

The site table subsystem 102 may incorporate an interface to accept requests such as the addition of a suggested stationary location to the site table, the addition of a suggested mobile unit to the site table, or the addition of a suggested stationary location cross-referencing a suggested mobile unit to the site table. If the suggestions are accepted, the site table 103 is updated in response to the requests.

In another aspect, the system 100 includes a targeting subsystem 130 with a valuation table 132. The value may be linked to a reward based upon location, mobile unit type, the projection of media, the type of media (if projected), time, or a combination of these variables, to name a few variables. Rewards may be issued to entities associated with the mobile unit and/or the system 100.

FIG. 2C is a diagram depicting a site table 103 cross-referenced to a valuation table 132. In this example, the weighted value is simply cross-referenced to stationary locations. However, as noted above, value may be weighted on other factors. Alternatively, the weighted values may be incorporated as a column in the site tables of FIG. 2A or 2B. Weighted values are typically established using geo-fencing services, such as provided by Radar Labs, Inc. Geo-fencing uses technologies like GPS, radio frequency identification (RFID), WiFi, cellular data, and internet protocol (IP) address ranges, to build virtual fences in geographic regions. These virtual fences can be used to track the physical location of a device (e.g., smartphone) active in the particular region or the fence area. The location of the person using the device is taken as geocoding data and can be used construct a picture of IP traffic in those areas. However, the geo-fencing information used to support the above-described valuation table is typically not instantaneously updated. To support instantaneous real-time updates, the valuation table may receive geographic location local environmental data from network-connected media units. A mobile unit is potentially able to supply local environmental data from a camera, microphone, odor sensor, photodetector, chemical sensor, wireless spectrum receiver (e.g., detecting the noise floor in Bluetooth, WiFi, or cellular bands), wireless service traffic analyzer (e.g., detecting traffic through a publically accessible AP or the above-mentioned geo-fencing technologies), radiation sensor, local weather sensor (e.g., temperature or rain), and/or air quality monitor.

The weighted values may be associated with reward calculation based upon the selected stationary location. In addition to location, the reward calculation may also be responsive to considerations such as time, media message, local environment, and media unit type. As noted above, local environment factors may be measured and reported back to the targeting subsystem. The factors may include consideration outside the scope, or incorrectly perceived by geo-fencing, or may be temporary conditions (a blocked street or an unexpected crowd of people).

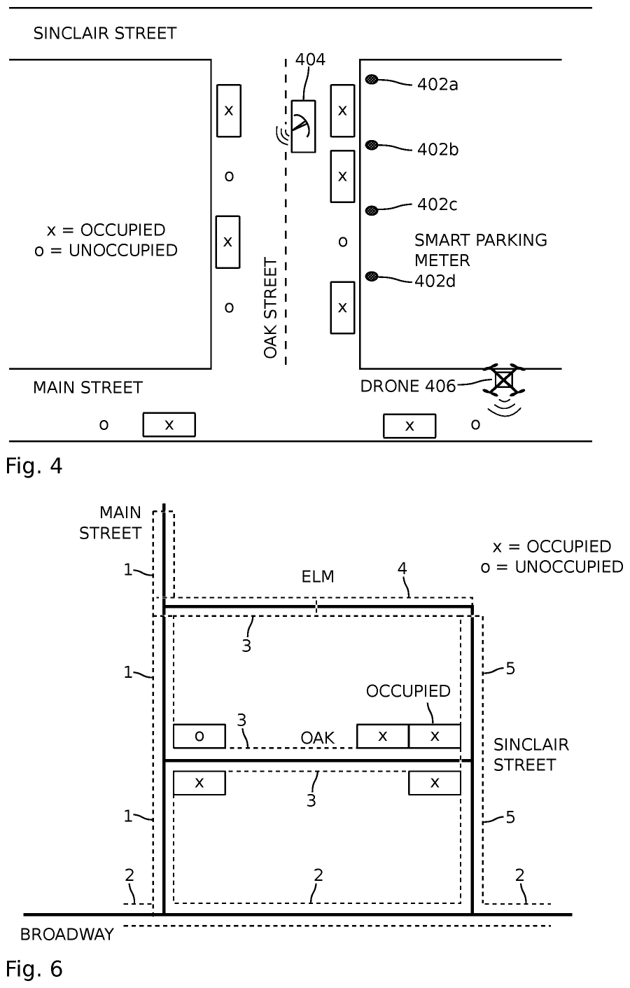

FIG. 4 is a diagram depicting a scouting subsystem. The scouting subsystem 400 determines the occupation status of stationary locations and reports the occupation status to the site table. In turn, the site table is updated to list the occupation status of the stationary locations. For example, the scouting subsystem 400 may incorporate “smart” parking meters 402a, 402b, 402c, and 402d that are able to communicate their status, which may be based on camera images or expiration time. In one aspect, city or private party operated cameras may be accessed. Otherwise, a human driven vehicle may manually report occupation status (e.g., a human phoning in status). In one aspect, a human driven vehicle or autonomous vehicle 404, drone aircraft 406, or satellites may use cameras to identify the occupied locations (marked with an “x”) or unoccupied spaces (marked with a “o”).

Returning to FIG. 1, the system 100 may further comprise a calendar subsystem 134 with a time table 136 listing a plurality of times that selected stationary locations are to be occupied. The time table 132 may be cross-referenced to a stationary location selection, and/or media units, and/or media messages, and/or valuations.

FIG. 5 is a schematic block diagram depicting an exemplary mobile unit. The mobile unit 118 described below may provide a number of functions and services. It should be understood that the mobile unit 118 need not incorporate all the services described below. In one aspect, the mobile unit may comprise a media projection subsystem 500, which may be selectively engaged in cooperation with the media messaging subsystem of FIG. 1, and which may supply an enablement signal (enablement acknowledgement) on bus line 502 when enabled. The media projection subsystem 500 has an interface, represented by reference designator 504, to project a form of media 506.

The media message subsystem of FIG. 1 (122) may supply media message enablement signals, for a selected media message, to the media unit 118. In one aspect, the media message subsystem transmits a selected media message to the media unit. In this case, the media unit 118 may be equipped with a local memory to store the received massage and a media projection subsystem display device, such as a light emitting diode (LED) or liquid crystal (LC) display that is able to project still images or video messages stored in local memory. Without imposing limitations on the system, some examples of media unit media projection subsystems also include an image projector, a retractable screen, a topper, holographic display, a light emitting diode display, wallscape, electroluminescent (EL) display, switchable glass displays, persistent image fan, or combinations thereof. The media projection subsystem 130 may be an image projector enabled as a liquid crystal (LC) or LED display similar to a home theater type video projector. Alternatively, high performance (e.g., mercury arc or xenon arc) lamps, cathode ray tube (CRT), digital light processing (DLP), plasma, silicon X-tal reflective display (SXRD), or red-green-blue (RGB) lasers may be used. In other words, the media projection subsystem 500 may present a 2-dimensional or 3-dimensional image, which may or may not be transitory. Transitory images include a series of still images, videos, or combinations thereof. The media projection subsystem 500 may also broadcast audio messages, or a combination for audio and visual messages.

Alternatively, or in addition, the media message subsystem cross-references locally stored media messages to mobile units storing the messages. In another aspect, the mobile unit 118 may be equipped with a printed screen image that is not easily updated, and in this case the selection of a particular message automatically selects the media unit associated with the non-updatable message. Alternatively, a digital display unit may be tasked with presented locally stored media if there is a communication problem preventing the downloading of media messages. Optionally, the media message subsystem may accept media message selections from a user permitting the user to add (e.g., upload) a media message to the media message subsystem (122, FIG. 1).

Typically, the mobile unit 118 further comprises a location subsystem 508 having an output on line 502 to supply a geographic location of the mobile unit. Examples of a location subsystem 508 include a Global Positioning Satellite (GPS) system receiver, assisted GPS taking advantage of cell tower data, a Wireless Local Area Network IEEE 802.11 (WiFi) positioning system, cell-site multilateration, satellite multilateration, or a hybrid positioning system. Hybrid positioning systems find locations using several different positioning technologies, such as GPS, combined with cell tower signals, wireless internet signals, Bluetooth sensors, IP addresses, and network environment data. Cell tower signals have the advantage of not being hindered by buildings or bad weather, but usually provide less precise positioning. WiFi positioning systems may give very exact positioning in urban areas with high WiFi density, depending on a comprehensive database of WiFi access points. Further, a LORAN type system or LoJack® type system might be adapted for the purpose of location determination. As noted in U.S. Pat. No. 10,796,340, which is incorporated herein by reference, camera images and the location data of proximate smartphones, laptops, and personal communication devices can also be used to determine location.

Optionally, the mobile unit 118 may further comprise a verifier, or verification subsystem, 510 with an interface on line 502. Here, the verifier 510 is enabled as a software application stored in local non-transitory memory 512, including processor executable instructions to receive location directions, media enablement signal, an identification code, and the geographic location, to supply verification information responsive to the direction and media enablement acknowledgements, the identification code, the geographic location. The determination of location may involve determining if the media unit is stationary or in motion, or durations of time the mobile unit is stationary or in motion. Alternatively, at least some components of the verifier 510 may be enabled in hardware.

The mobile unit 118 typically includes a communications subsystem 514. The communications subsystem 514 has an interface on line 502 to accept verification information, an interface to receive instructions, and an interface to communicate the verification information. As shown, the communications subsystem 514 is in communication with network 114. The most typical examples of a wireless communication subsystem 514 are cellular systems (e.g., Global System for Mobile Communications (GSM), Universal Mobile Telecommunications System (UMTS)-time division duplexing (TDD), Long-Term Evolution (LTE), 4th Generation (4G), or 5th Generation (5G)), and the like. Less typically, the communications subsystem 514 may be enabled with WLAN IEEE 802.11 (WiFi), or even Long Range Wireless transceiver. Some examples of a Long Range Wireless system include Digital Enhanced Cordless Telecommunications (DECT), Evolution-data Optimized (EVDO), General Packet Radio Service (GPRS), High Speed Packet Access (HSPA), IEEE 802.20 (iBurst), Multichannel Multipoint Distribution Service (MMDS), Muni WiFi, commercial satellite, and IEEE 802.16 Worldwide Interoperability for Microwave Access (WiMAX (WiBro)). As another alternative, the communication subsystem may store verification information and other communication messages in the system local memory 512 as data 516, which may be periodically downloaded using a wireless or hardwire connection. The mobile unit 118 is not limited to any particular type of communication subsystem.

Optionally, the communication subsystem 514 may further comprise a publically accessible transceiver such as a cellular telephone or Internet local booster 520, an access point (AP) 518 selected from the group consisting of an IEEE 802.11 Wireless Local Area Network (WLAN) AP, an IEEE 802.15 Wireless Personal Area Network (WPAN) AP, or combinations thereof. Alternatively, but less common, the access point may an IEEE 802.15.4 Zigbee, WPAN IEEE 802.15 Li-Fi or wireless USB device. Even more unlikely as an access point are Long Range Wireless systems. As used herein, a “publically accessible” is a system that can be accessed by the general public without a password or similar security measures, or where the password is publically distributed. One example of a publically accessible AP is the WiFi hotspot service provided by a typical Starbucks coffee shop. In the case of a password being required for access, the password may be printed on the mobile platform, displayed by the media projection subsystem, or made available through a media projection phone application or website.

In one aspect, the access point and/or communications subsystem can be used to collect data from entities passing by, or engaging with the access point or using the communications subsystem. This data can be stored in local memory 512 for subsequent recovery or transmission to the server in support of data gathering or geo-fencing data. In support of data mapping, the access point is publically accessible to user devices that include smartphones, personal devices, or generally any type of computing device. Typically, the user devices are enabled for WiFi and Bluetooth communications. If left enabled, as is the typical case for many users, the user device is able to interact with a nearby access point even if a communication data link is not established. As used herein, the term data mapping includes the collection of data from the user devices. In one aspect, user data information (e.g., addresses) is collected voluntarily, with the user explicitly agreeing to data collection in response to an access point provided services, such as the provision of an Internet browser, email, Internet, or social media services. For example, if the access point is a WiFi hotspot that accepts Uniform Resource Locator (URL) address requests from a user device (e.g., a smartphone), the URL address requests may be transmitted to a Domain Name System (DNS) service embedded with the computer system hosting the system of FIG. 1. The DNS service makes address searches. Otherwise, the information is collected without an explicit agreement by the user, where legal. Rewards to entities may be based upon the volume of traffic through the WiFi hotspot or access point data collected. In some aspects, camera images, in cooperation with a facial recognition software application (e.g., DeepFace), are used for data tracking.

As noted above, the communications subsystem may include a signal booster 520, such as a device provided by WeBoost, or a similarly functioning proprietary device. The booster may act as a relay between a proximately located user cellular device 522 and a cellular network (i.e., base station or satellite). In other aspects, a signal booster 520 acts to relay Internet signals, such as might be useful when employed with the StarLink or similar Internet service, as the StarLink ground units require an uninterrupted view of the sky (i.e., view of the StarLink satellites) For example, the mobile unit may be positioned in areas of weak cellular coverage. Using the site selection and targeting components mentioned above, mobile media units can be directed to, and rewarded for established cellular boosters in poor coverage areas. Improved cellular coverage necessary improves Internet and WiFi services carried by the cellular service.

In the case of a mobile unit independently selecting its location, the mobile unit 118 may incorporate a targeting subsystem 524 to support the selection of stationary locations, which may have corresponding location values. As shown, the targeting subsystem 524 is enabled as software application stored in local memory 512. In some variations the targeting subsystem may be enabled with hardware, or even as a manual hardcopy list. The listed stationary locations may be associated with rewards provided to an entity. The entities involved may include the entity managing the system of FIG. 1 (100), the user making the location selections, the entity managing the mobile unit, an entity owning the property upon which the mobile unit is located, or combinations of the above-mentioned entities. As used herein, an “entity” may be a person, a business, a corporation, any type of social organization or business unit, a physical device, or a software application. For simplicity, the entities may be identified as the hardware components being used by, or associated with a business, person, corporation, or social organization. In this case, the entity may be described as a computer, smartphone, media projection subsystem, server, or vehicle, to name a few examples. Although not explicitly shown, the targeting subsystem may alternatively or additionally embedded with the system memory of FIG. 1 (104).

The mobile unit 118 may include a camera 526 to record images of the geographic location proximate to the media unit. The camera images may be stored in local memory 512, or the communications subsystem 514 may transmit the images. In one aspect, the camera may also be used to modify the value of the target location. For example, the recorded traffic in a location may be greater than anticipated, and the weighted value adjusted accordingly. That is, images recording higher pedestrian or vehicular traffic may indicate, at least temporarily, a greater location value. The data may be used to help determine the efficacy of the media or location. Alternatively or in addition, the camera images my act to verify that the media projector subsystem 130 has been enabled, media unit movement, or lack thereof, or identification of a particular location. In one aspect, simply recording a change in images, and thus proximate traffic, can be used as a means for proving media projector subsystem enablement. As an alternative, or in addition to the camera, the system may further comprise a proximity detector subsystem to sense nearby motion, or to measure the density of proximate vehicular or foot traffic, which data is transmitted by the communications subsystem or recorded in local memory.

As noted in the description of FIG. 1, the mobile unit may further incorporate a locking mechanism 528 that permits the requesting entity to take possession of the mobile unit, and a controller 530 that permits the mobile unit 118 to be moved.

FIG. 6 is a plan view of geographic regions cross-referenced to the weighted value of various positions. As shown, regions along Main Street have a value of 1, the highest rated value. The regions along Broadway have a value of 2. The regions along Oak have a value of 3. The region along Elm near Main Street have a value of 3, which decreases to a value of 4 near Sinclair Street, and the regions along Sinclair Street have a value of 5. The site table subsystem may include a listing of occupied spaces along Oak Street (as marked with an “x”), as may list a stationary location along Oak Street (as marked with an “o”) available for selection.

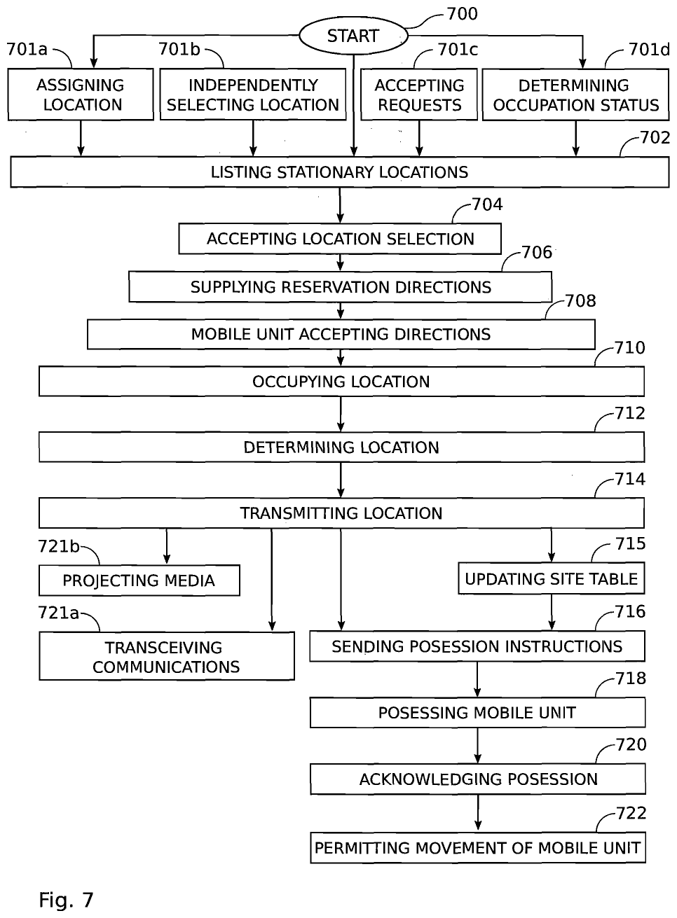

FIG. 7 is a flowchart illustrating a method for reserving publically accessible real estate locations. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method steps are supported by the above system descriptions and, generally, the method follows the numeric order of the depicted steps. The method starts at Step 700.

In Step 702 a site table lists a plurality of publically accessible stationary locations. In one aspect, the stationary locations are parking locations. In another aspect, the site table cross-references publically accessible stationary locations to types of mobile units. Alternatively or in addition, the site table may cross-reference stationary locations to weighted values. In Step 704 the site table accepts stationary location selection requests. In Step 706 the site table supplies location reservation directions to a mobile unit, to a selected location. In Step 708 a mobile unit accepts reservation directions and occupies the selected location in Step 710. The mobile unit may be a self-powered vehicle, towable vehicle, portable station, ground vehicle, nautical vehicle, or airborne vehicle. In Step 712 the mobile unit determines (verifies) its geographic location, and in Step 714 the mobile unit transmits the geographic location and an acknowledgement that the mobile unit occupies the selected location.

In one aspect, the site table sends possession instructions in Step 716 for a first mobile unit receiving direction instructions. Possession of the first mobile unit occurs in Step 718 in response to the occupation instructions. In Step 720 the mobile unit transmits an acknowledgement that possession of the mobile unit has occurred. In one variation, subsequent to possession of the first mobile unit, Step 722 permits movement of the mobile unit to a new location. Alternatively, the mobile unit leaves the reserved location upon the arrival of the user making the location request, so that the location can be occupied by another mobile unit.

In another variation, the site table assigns stationary locations to mobile units in Step 701a, prior to their selection in Step 704. Subsequent to a first mobile unit occupying an assigned stationary location in Step 710, in Step 715 the site table is updated to list the first mobile unit as being positioned at the assigned location. In a related variation, the site table accepts requests in Step 701c such as the addition of a suggested stationary location to the site table, the addition of a suggested mobile unit to the site table, or the addition of a suggested stationary location cross-referencing a suggested mobile unit to the site table. In Step 702 the site table is updated in response to requests.

In one aspect, the mobile unit transceives publically accessible communications in Step 721a using a device such as a cellular telephone local booster, Internet booster, an access point (AP) selected from the group consisting of an IEEE 802.11 Wireless Local Area Network (WLAN) AP, an IEEE 802.15 Wireless Personal Area Network (WPAN) AP, or combinations thereof. In another aspect, in Step 721b the mobile units projects media messages using a media projection subsystem.

In one variation, the site table receives a message from a mobile unit in Step 701b indicating the occupation of an independently selected stationary location. Then in Step 702, the site table is updated to list the addition of the independently selected stationary location.

In one aspect, a scouting subsystem in Step 701d determines the occupation status of stationary locations and reports the occupation status to the site table. Then in Step 702 the site table is updated to list the occupation status of the stationary locations. In another aspect, the mobile unit transmitting the geographic location in Step 714 includes transmitting local environmental data such as images, sounds, weather, odors, photodetection, chemical analysis, wireless spectrum analysis, wireless service traffic analysis, radioactivity analysis, air quality analysis, or combinations thereof. Then in Step 702, then the weighted values are modified in response to the local environmental data.

Systems and methods have been provided for mobile unit location reservations. Examples of particular message structures, schematic block linkages, and hardware units have been presented to illustrate the invention. However, the invention is not limited to merely these examples. Other variations and embodiments of the invention will occur to those skilled in the art.

We claim:

1. A system for reserving publically accessible real estate locations, the system comprising:
a site table listing a plurality of publically accessible stationary locations;
an interface for accepting stationary location requests and supplying location reservation directions to a selected location; and,
a mobile unit having an interface to accept reservation directions and the capacity to temporarily occupy selected locations.

2. The system of claim 1 wherein the mobile unit comprises:
a location device to determine a geographic location of the mobile unit; and,
a communication subsystem to accept the reservation directions, and supply the geographic location with an acknowledgement that the mobile unit occupies the selected location.

3. The system of claim 2 wherein the site table has an interface for sending occupation instructions for a first mobile unit receiving direction instructions; and,
wherein possession of the first mobile unit occurs in response to the occupation instructions.

4. The system of claim 3 wherein the mobile unit further comprises:
a monitoring subsystem comprising sensors for determining possession of the first mobile unit; and,
wherein the first mobile unit transmits an acknowledgement that possession has occurred.

5. The system of claim 3 wherein the mobile unit further comprises:
a control subsystem permitting movement of the first mobile unit subsequent to possession.

6. The system of claim 1 wherein the site table has an interface for assigning locations to mobile units, prior to their selection; and,
wherein the site table is updated to list mobile units after being positioned at their assigned locations.

7. The system of claim 1 wherein the mobile unit further comprises a publically accessible transceiver selected from the group consisting of a cellular telephone local booster, Internet booster, an access point (AP) selected from the group consisting of an IEEE 802.11 Wireless Local Area Network (WLAN) AP, an IEEE 802.15 Wireless Personal Area Network (WPAN) AP, and combinations thereof.

8. The system of claim 1 wherein the mobile unit is selected from the group consisting of self-powered vehicles, towable vehicles, portable stations, ground vehicles, nautical vehicles, and airborne vehicles.

9. The system of claim 1 wherein the mobile unit further comprises:
a media projection subsystem for projecting a media message.

10. The system of claim 1 wherein a first mobile unit sends a message to the site table indicating the occupation of an independently selected stationary location; and,
wherein the site table is updated to list the addition of the independently selected stationary location.

11. The system of claim 1 wherein the site table cross-references publically accessible stationary locations to types of mobile units.

12. The system of claim 11 wherein the site table has an interface to accept requests selected from the group consisting of an addition of a suggested stationary location to the site table, an addition of a suggested mobile unit to the site table, and the addition of a suggested stationary location cross-referencing a suggested mobile unit to the site table; and,
wherein the site table is updated in response to the requests.

13. The system of claim 1 further comprising:
a valuation table cross-referencing stationary locations to weighted values.

14. The system of claim 1 further comprising:
a scouting subsystem determining the occupation status of stationary locations and reporting the occupation status to the site table; and,
wherein the site table is updated to list the occupation status of the stationary locations.

15. The system of claim 1 wherein the mobile unit further comprises:
sensors to receive local environmental data from devices selected from the group consisting of cameras, microphones, weather sensors, odor sensors, photodetectors, chemical sensors, wireless spectrum receiver, wireless service traffic analyzer, radiation sensor, air quality monitor, and combinations thereof.

16. The system of claim 15 wherein the system further comprises:
a valuation table cross-referencing stationary locations to weighted values; and,
wherein the valuation table has an interface to receive local environmental data and update the weighted values in the valuation table in response to the local environmental data.

17. A method for reserving publically accessible real estate locations, the method comprising:
a site table listing a plurality of publically accessible stationary locations;
the site table accepting stationary location selection requests;
the site table supplying location reservation directions to a selected location; and,
a mobile unit accepting reservation directions; and,
the mobile unit occupying the selected location.

18. The method of claim 17 further comprising:
the mobile unit determining its geographic location; and,
the mobile unit transmitting the geographic location with an acknowledgement that the mobile unit occupies the selected location.

19. The method of claim 17 further comprising:
the site table sending possession instructions for a first mobile unit receiving direction instructions; and,
possession of the first mobile unit occurring in response to the possession instructions.

20. The method of claim 19 further comprising:
subsequent to possession of the first mobile unit, permitting movement of the mobile unit to a new location.

21. The method of claim 17 further comprising:
the site table assigning stationary locations to mobile units, prior to their selection; and,
subsequent to a first mobile unit occupying an assigned stationary location, the site table being updating to list the first mobile unit as being positioned at the assigned location.

22. The method of claim 17 further comprising:
the mobile unit transceiving publically accessible communications using a device selected from the group consisting of a cellular telephone local booster, Internet booster, an access point (AP) selected from the group consisting of an IEEE 802.11 Wireless Local Area Network (WLAN) AP, an IEEE 802.15 Wireless Personal Area Network (WPAN) AP, and combinations thereof.

23. The method of claim 17 wherein the mobile unit is selected from the group consisting of self-powered vehicles, towable vehicles, portable stations, ground vehicles, nautical vehicles, and airborne vehicles.

24. The method of claim 17 further comprising:
the mobile units projecting media messages using a media projection subsystem.

25. The method of claim 17 further comprising:
the site table receiving a message from a mobile unit indicating the occupation of an independently selected stationary location; and,
wherein the site table listing stationary locations includes the site table being updated to list the addition of the independently selected stationary location.

26. The method of claim 17 wherein the site table listing stationary locations includes the site table cross-referencing publically accessible stationary locations to types of mobile units.

27. The method of claim 17 further comprising{
the site table accepting requests selected from the group consisting of an addition of a suggested stationary location to the site table, an addition of a suggested mobile unit to the site table, and the addition of a suggested stationary location cross-referencing a suggested mobile unit to the site table; and,
wherein the site table listing stationary locations includes the site table being updated in response to requests.

28. The method of claim 17 wherein the site table cross-references stationary locations to weighted values.

29. The method of claim 18 wherein the mobile unit transmitting the geographic location includes the mobile unit transmitting local environmental data selected from the group consisting of images, sounds, weather, odors, photodetection, chemical analysis, wireless spectrum analysis, wireless service traffic analysis, radioactivity analysis, air quality analysis, and combinations thereof.

30. The method of claim 29 wherein the site table cross-references stationary locations to weighted values, and updates the weighted values in response to the local environmental data.
